(19) United States
(12) Patent Application Publication
(10) Pub. No.: US 2007/0271468 A1
(43) Pub. Date: Nov. 22, 2007

(54) Method and Apparatus for Maintaining Data Integrity When Switching Between Different Data Protection Methods

(76) Inventors: Paul Edward McKenney, Beaverton, OR (US); Jeffrey William Palm, Rochester, MN (US); George Oliver Penokie, Rochester, MN (US); Mark Francis Wilding, Barrie (CA)

Correspondence Address: IBM CORPORATION;ROCHESTER IP LAW DEPT 917, 3605 HIGHWAY 52 N, ROCHESTER, MN, 55901-7829, US

(21) Appl. No.: 11/381,767

(22) Filed: May 5, 2006

(51) Int. Cl. G06F 12/14

(52) U.S. Cl. 713/189

(57) ABSTRACT

A method and apparatus are provided for maintaining data integrity when switching between data protection methods. Data and a first protection type information are received. A second protection type information is generated. After generating the second protection type information, the data is checked using the first protection type information. An error indication is generated when the first protection type information check fails.

### FIELD OF THE INVENTION

The present invention relates generally to the data processing field, and more particularly, relates to a method and apparatus for maintaining data integrity when switching between different data protection methods.

### DESCRIPTION OF THE RELATED ART

When transmitting blocks of data from host applications to storage devices, for example, disk drives, it is common practice to protect each block of data with some form of checksum or cyclic redundant code (CRC). To provide end-to-end protection the protection should be generated close to the point of origin, checked at the destination during a write operation, and then checked again at the point of use when read back. Typically, to accomplish this, one type of protection is used throughout the send and return path.

A problem occurs in that the most common and powerful protection techniques used in data transports are processor intensive when calculated using software but are quick and simple using hardware. Typically two or more data protection techniques including one that is quick for software and another that is quick on hardware are used to solve this problem.

For example, FIGS. 1A and 1B, illustrate such use of two or more data protection techniques. First data from a source are verified using protection type 1 information at a receiving device. If the protection type 1 check failed, then the source is notified of the protection type 1 data error. Otherwise, when the protection type 1 check does not fail, then a different protection type 2 information is generated and data together with protection type 2 information is transmitted to the destination.

A resulting problem with this technique is that the data is not protected between the time it is checked using protection type 1 information to the time the new protection type 2 information is generated. During this gap, no matter how small, the data could be corrupted. If that happens the corrupted data is unknowingly used to generate the new protection and therefore looks like valid data from that point on.

A need exists for an effective mechanism and method for maintaining data integrity when switching between data protection methods.

### SUMMARY OF THE INVENTION

Principal aspects of the present invention are to provide a method and apparatus for maintaining data integrity when switching between data protection methods. Other important aspects of the present invention are to provide such method and apparatus for maintaining data integrity when switching between data protection methods substantially without negative effect and that overcome many of the disadvantages of prior art arrangements.

In brief, a method and apparatus are provided for maintaining data integrity when switching between data protection methods. Data and a first protection type information are received. A second protection type information is generated. After generating the second protection type information, the data is checked using the first protection type information. An error indication is generated when the first protection type information check fails.

In accordance with features of the invention, maintaining data integrity is implemented using one of a plurality of methods. In one method, the first protection type information is stored. The second protection type information, such as a CRC is generated and simultaneously the data are verified using the saved first protection type information, such as a checksum, before transmitting the data. The second protection type information or checksum is stored. When the first protection type information check fails, the data source is notified of the error. When the first protection type information check does not fail, the data with the second protection type information or CRC are transmitted to a destination.

In accordance with features of the invention, in a second method, the first protection type information is stored. The second protection type information, such as a CRC is generated and simultaneously the data are verified using the saved first protection type information, such as a checksum, while transmitting the data. When the first protection type information check fails, an invalid second protection type information or CRC are transmitted to a destination, so a next data check will fail.

In accordance with features of the invention, in another method, data and the first protection type information are stored. The second protection type information, such as a CRC, is generated and placed in memory. Then data are checked using the saved first protection type information, such as a checksum. When the first protection type information check fails, the data source is notified of the error. When the first protection type information check does not fail, the data with the second protection type information or CRC are transmitted to a destination.

In accordance with features of the invention, in yet another method, data on receipt are checked using the first protection type information, such as a checksum and simultaneously second protection type information, such as a CRC, is generated, while transmitting the data. When the first protection type information check fails, an invalid second protection type information or CRC are transmitted to a destination, so a next data check will fail.

In accordance with features of the invention, in still another method, data on receipt are checked using the first protection type information, such as a checksum. When the first protection type information check fails, the data source is notified of the error. Otherwise when the first protection type information check does not fail, the data and the first protection type information are stored. The second protection type information, such as a CRC, is generated and placed in memory. Then data are checked using the saved first protection type information. When the first protection type information check fails, the data source is notified of the error. When the first protection type information check does not fail, the data with the second protection type information or CRC are transmitted to a destination.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B illustrate prior art exemplary operations when sending data from a source to a destination and switching between different data protection methods;

FIGS. 2A and 2B, 3A and 3B, 4A and 4B, 5A and 5B, and 6A and 6B are flow charts and block diagrams respectively illustrating exemplary steps and apparatus for maintaining data integrity when sending data from a source to a destination and switching between data protection methods in accordance with the preferred embodiment.

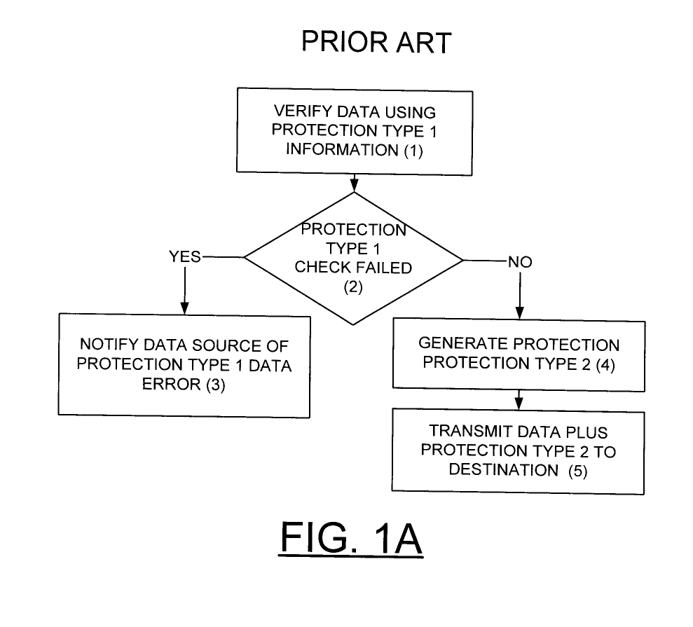

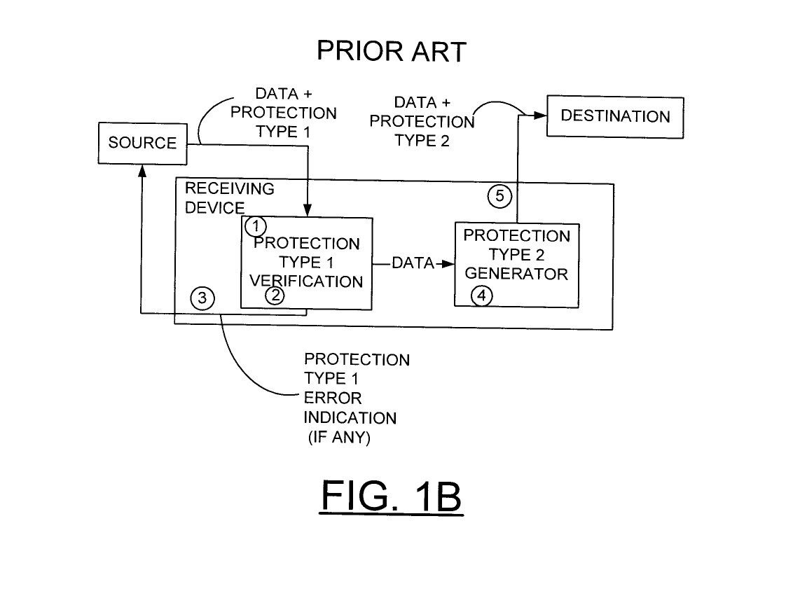

### DETAILED DESCRIPTION OF THE PREFERRED EMBODIMENTS

In conventional arrangements when a device is converting from one protection technique to another, or has to regenerate the protection, that device checks that the data is valid using the received protection technique as the data is received and then generates the new protection as the data is transmitted, resulting in a time gap between data checking and the new protection being generated.

In accordance with features of the invention, enhanced methods are provided for maintaining data integrity when sending data from a source to a destination and switching between data protection methods. Methods of the preferred embodiments are provided to overlap different protection techniques to assure the data is protected 100% of the time while one protection technique, for example, checksum, is being transitioned to another protection technique, for example, cyclic redundant code (CRC).

In accordance with features of the invention, a receiving device is provided for saving the incoming protection information and then after the generation of the outgoing protection, a check of the data is performed using the incoming protection information.

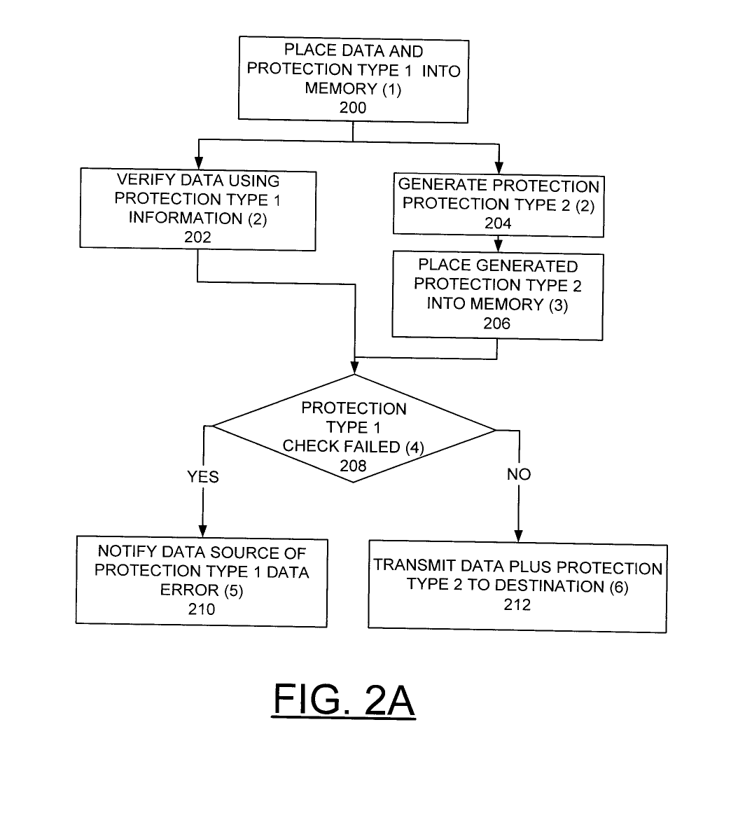

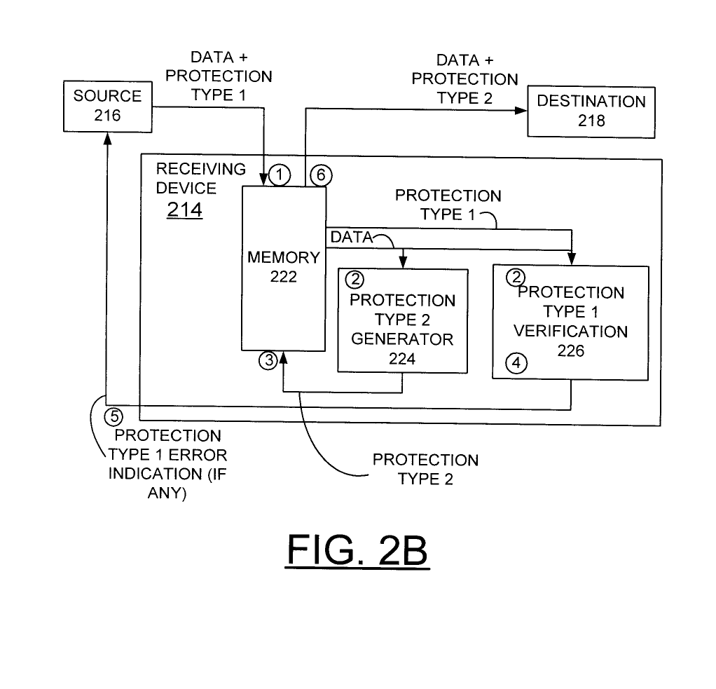

Having reference now to the drawings, FIGS. 2A and 2B respectively illustrate exemplary steps of a first method and apparatus for maintaining data integrity when sending data from a source to a destination and switching between data protection methods in accordance with one preferred embodiment. In FIG. 2B, encircled numbers shown within the receiving device 214 indicates exemplary method steps with the corresponding steps shown in parenthesis in the flow chart of FIG. 2A.

As shown in FIG. 2A, in a first step of the first method of a preferred embodiment performed by the receiving device 214, received data together with protection type 1 is placed into memory as indicated in a block 200.

Next the received data is verified using the protection type 1 information as indicated in a block 202. Simultaneously with verifying the received data, protection type 2 information is generated for the received data as indicated in a block 204 and the generated protection type 2 information is stored into memory as indicated in a block 206.

Next determining whether the protection type 1 information check failed as indicated in a decision block 208. When the determined that the protection type 1 information check failed, then the data source is notified as indicated in a block 210. Otherwise when the determined that the protection type 1 information check has not failed, then the data and the generated protection type 2 information are transmitted to the destination as indicated in a block 212.

As shown in FIG. 2B, a receiving device 214 receives data together with protection type 1 from a source 216, such as a host application, to send the data together with protection type 2 information to a destination 218. For example, the receiving device 214 is a host bus adapter (HBA) receiving data together with protection type 1 information from the source 216 or a host application, sending data to the destination 218, such as a storage device, for example, a disk drive with protection type 2 information. The receiving device 214 includes a memory 222 for storing data, protection type 1 information, and protection type 2 information, a protection type 2 generator function 224 receiving data and generating protection type 2 information, and a protection type 1 verification function 226 receiving data and verifying protection type 1 information.

One exemplary implementation of protection type 1 information is a checksum protection information technique, for example, Fletcher-32 checksum protection information that can be calculated very quickly in using standard software techniques at the application or source 216. Then, for example, on a write operation the protection type 1 information is stored into memory 222 and remains with the data that is received by the receiving device 214. Receiving device 214 is, for example, a host bus adapter (HBA), such as a PCI-X to Fibre Channel HBA.

HBA or receiving device 214 converts the protection type 1 information checksum to a different protection type 2 information technique for the data, such as CRC-32 or CRC-16. The different protection type 2 information, such as CRC-32 or CRC-16 is generated for the data at the protection type 2 generator function 224, and the data is checked using the saved protection type 1 information or checksum at the protection type 1 verification function 226. On a read operation the process is reversed.

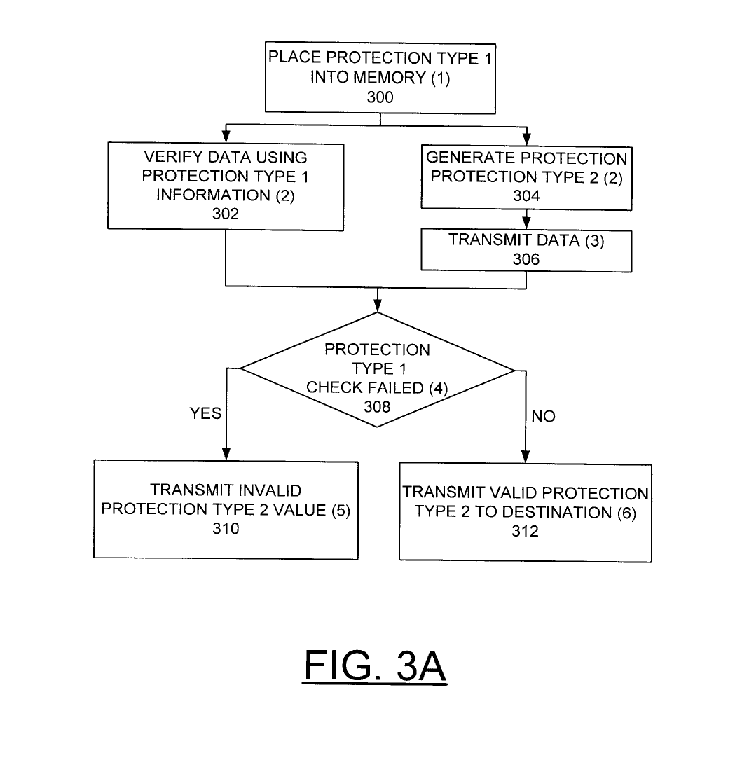

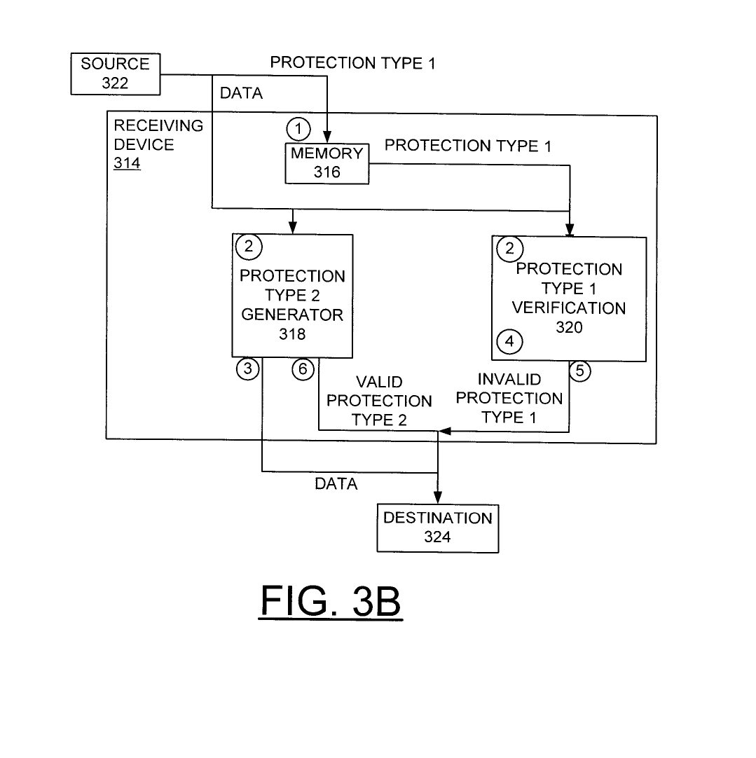

Referring now to FIGS. 3A and 3B, there are shown exemplary steps of a second method and apparatus for maintaining data integrity when sending data from a source to a destination and switching between data 30 protection methods in accordance with one preferred embodiment. In FIG. 3A, exemplary method steps are shown in parenthesis in the flow chart; and in FIG. 3B, encircled numbers within a receiving device 314 illustrates corresponding steps.

Referring first to FIG. 3B, the receiving device 314 is arranged differently from the receiving device 214 for performing the second method of a preferred embodiment. The receiving device 314 includes a memory 316 for protection type 1 information, a protection type 2 generator function 318 receiving data and generating protection type 2 information, and a protection type 1 verification function 320 receiving data and protection type 1 information and verifying protection type 1 information. Receiving device 314 receives data together with protection type 1 from a source 322, such as a host application, to send the data together with protection type 2 information to a destination 324, such as a disk drive.

Referring to FIG. 3A, as indicated in a block 300 in a first step performed by receiving device 314, received protection type 1 information is placed into the memory 316. The received data is verified by protection type 1 verification function 320 using the protection type 1 information as indicated in a block 302. Simultaneously with verifying the received data at block 302, protection type 2 information is generated for the received data as indicated in a block 304 and the data is transmitted to the destination 324 as indicated in a block 306.

Next determining whether the protection type 1 information check failed as indicated in a decision block 308. When determined that the protection type 1 information check failed, then the destination is notified of the invalid transmitted data by transmitting invalid protection type 2 information as indicated in a block 310. Otherwise when determined that the protection type 1 information check has not failed, then the generated protection type 2 information are transmitted to the destination as indicated in a block 312.

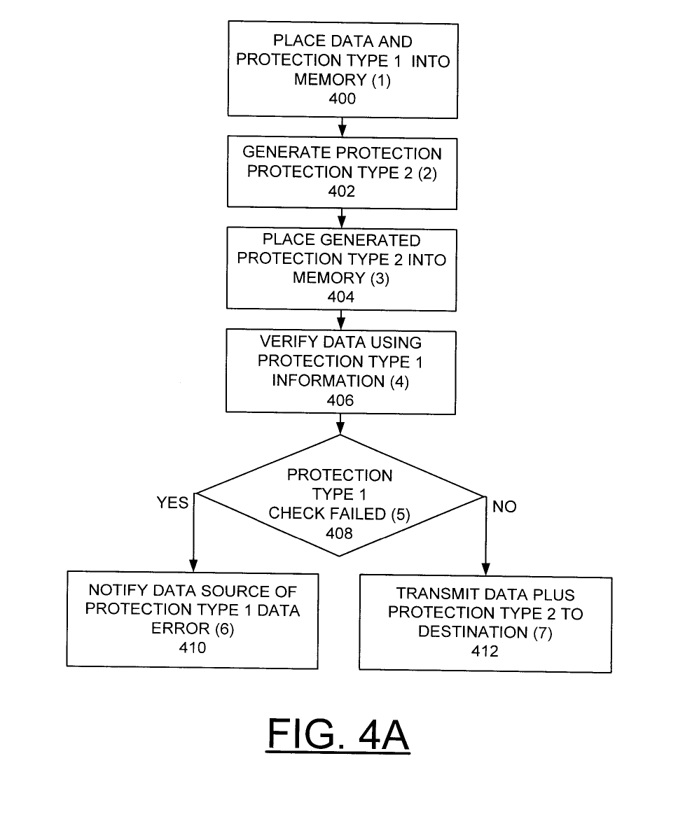

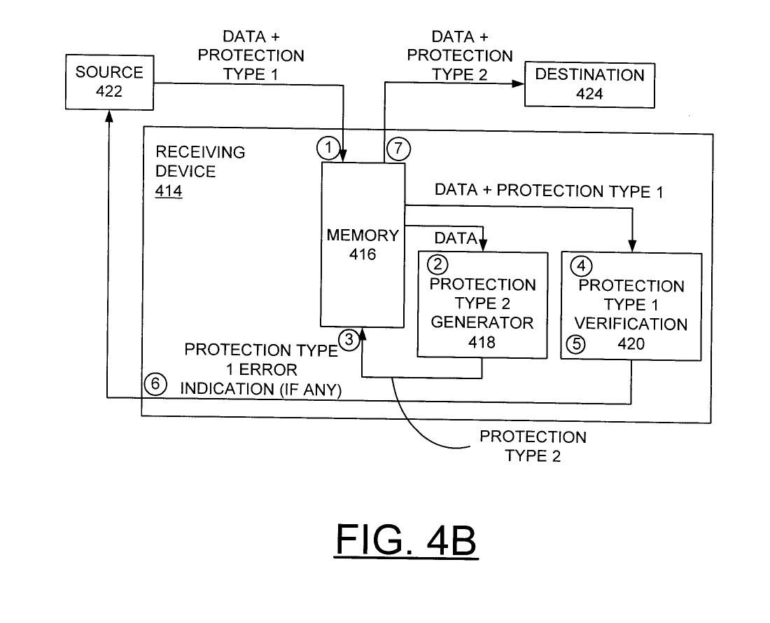

Referring now to FIGS. 4A and 4B, there are shown exemplary steps of a third method and apparatus for maintaining data integrity when sending data from a source to a destination and switching between data protection methods in accordance with one preferred embodiment. In FIG. 4A, exemplary method steps are shown in parenthesis in the flow chart; and in FIG. 4B, encircled numbers within a receiving device 414 illustrates corresponding steps.

Referring first to FIG. 4B, the receiving device 414 is arranged differently from the receiving devices 214 and 314 for performing the third method of a preferred embodiment. The receiving device 414 includes a memory 416 for storing both data and protection type 1 information, a protection type 2 generator function 418 receiving data and generating protection type 2 information, and a protection type 1 verification function 420 receiving data and protection type 1 information and verifying protection type 1 information. Receiving device 414 receives data together with protection type 1 from a source 422, such as a host application, to send the data together with protection type 2 information to a destination 424, such as a disk drive.

Referring to FIG. 4A, as indicated in a block 400 in a first step performed by receiving device 414, received data protection type 1 information is placed into the memory 416. Protection type 2 information is generated for the received data as indicated in a block 402. The protection type 2 information is placed into memory 416 as indicated in a block 404. The received data is verified by protection type 1 verification function 420 using the protection type 1 information as indicated in a block 406.

Next determining whether the protection type 1 information check failed as indicated in a decision block 408. When determined that the protection type 1 information check failed, then the data source 422 is notified of the protection type 1 error as indicated in a block 410. Otherwise when the determined that the protection type 1 information check has not failed, then the data and the generated protection type 2 information are transmitted to the destination 424 as indicated in a block 412.

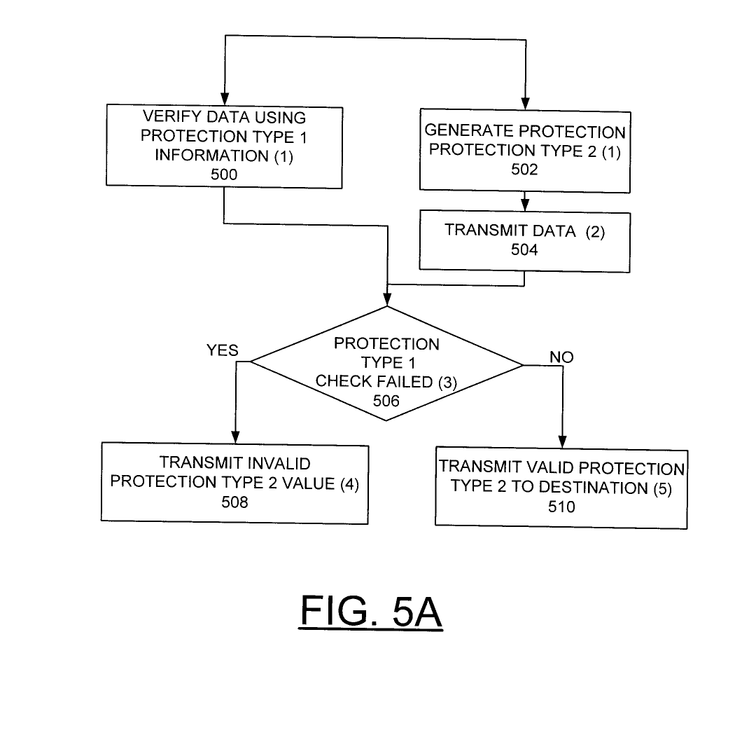

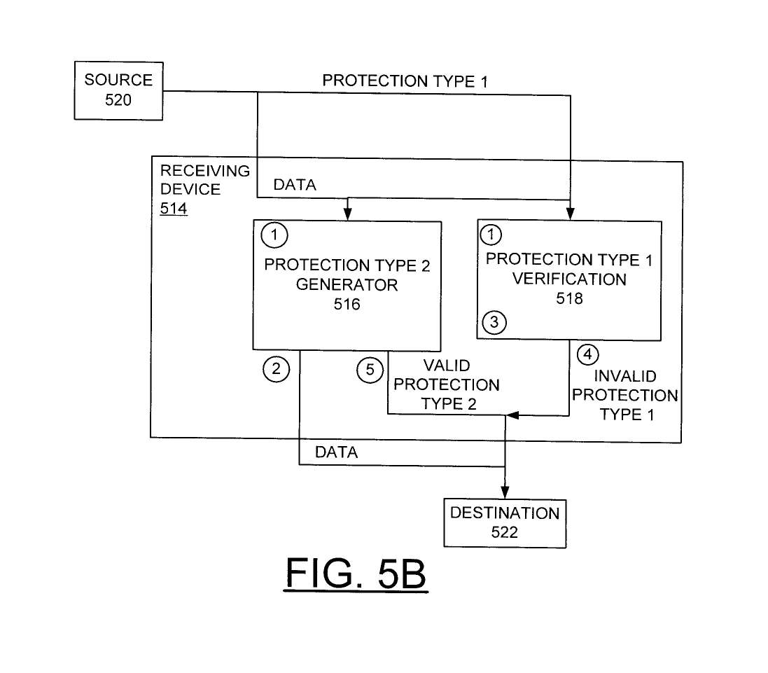

Referring now to FIGS. 5A and 5B, there are shown exemplary steps of a fourth method and apparatus for maintaining data integrity when sending data from a source to a destination and switching between data protection methods in accordance with one preferred embodiment. In FIG. 5A, exemplary method steps are shown in parenthesis in the flow chart; and in FIG. 5B, encircled numbers within a receiving device 514 illustrates corresponding steps.

Referring first to FIG. 5B, the receiving device 514 is arranged differently from the receiving devices 214, 314, and 414 for performing the fourth method of a preferred embodiment. The receiving device 514 includes a protection type 2 generator function 516 receiving data and generating protection type 2 information, and a protection type 1 verification function 518 receiving data and protection type 1 information and verifying data using protection type 1 information. Receiving device 514 receives data together with protection type 1 from a source 520, such as a host application, to send the data together with protection type 2 information to a destination 522, such as a disk drive.

Referring to FIG. 5A, as indicated in a block 500 in a first step performed by receiving device 514, data is verified using received protection type 1 information. Simultaneously with verifying the received data at block 500, protection type 2 information is generated for the received data as indicated in a block 502 and the data is transmitted to the destination 522 as indicated in a block 504.

Next determining whether the protection type 1 information check failed as indicated in a decision block 506. When determined that the protection type 1 information check failed, then the destination is notified of the invalid transmitted data by transmitting invalid protection type 2 information as indicated in a block 508. Otherwise when determined that the protection type 1 information check has not failed, then the generated protection type 2 information are transmitted to the destination as indicated in a block 510.

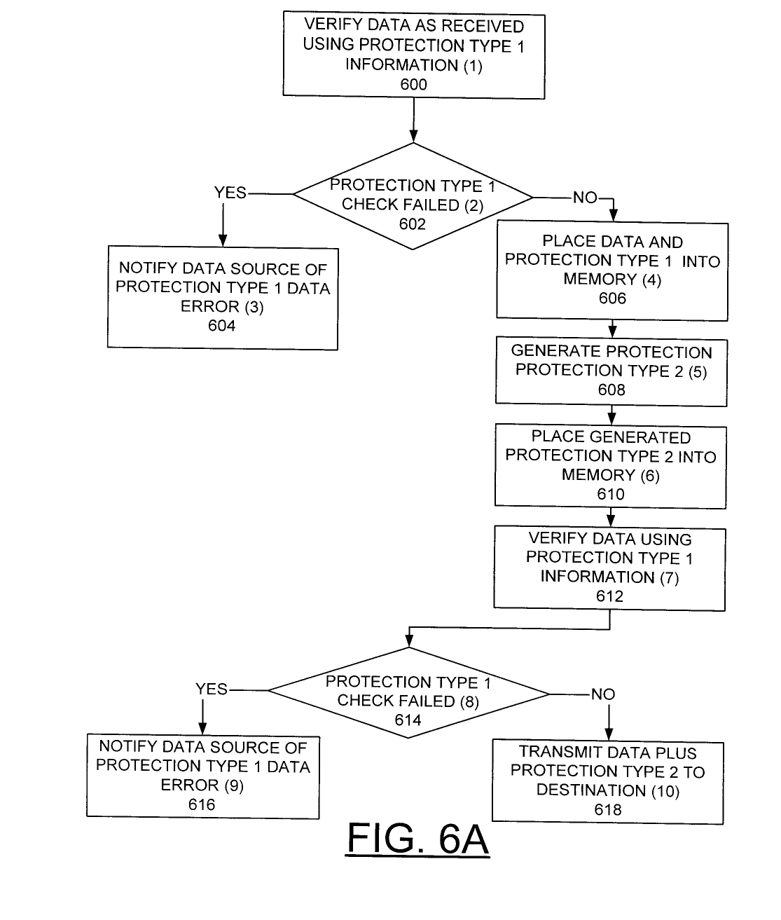

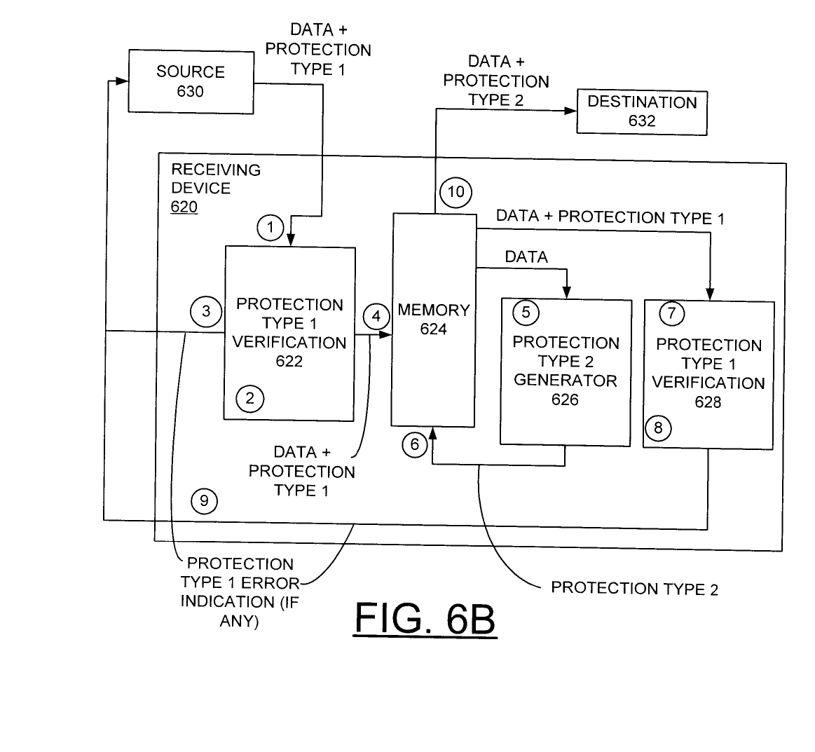

Referring now to FIGS. 6A and 6B, there are shown exemplary steps of a fifth method and apparatus for maintaining data integrity when sending data from a source to a destination and switching between data protection methods in accordance with one preferred embodiment. In FIG. 6A, exemplary method steps are shown in parenthesis in the flow chart; and in FIG. 6B, encircled numbers within a receiving device 620 illustrates corresponding steps.

Referring first to FIG. 6B, the receiving device 620 is arranged differently from the receiving devices 214, 314, 414 and 514 for performing the fifth method of a preferred embodiment. The receiving device 620 includes a first protection type 1 verification function 622 receiving data and protection type 1 information and verifying data using protection type 1 information, a memory 624 coupled to the first protection type 1 verification function 622 for storing both data and protection type 1 information, a protection type 2 generator function 626 receiving data and generating protection type 2 information, and a second protection type 1 verification function 628 coupled to the memory 624 receiving data and protection type 1 information and verifying protection type 1 information. Receiving device 620 receives data together with protection type 1 from a source 630, such as a host application, to send the data together with protection type 2 information to a destination 632, such as a disk drive.

Referring to FIG. 6A, as indicated in a block 600 in a first step performed by receiving device 620, data is verified as received using protection type 1 information. Next determining whether the protection type 1 information check failed as indicated in a decision block 602. When determined that the protection type 1 information check failed, then the data source 630 is notified of the protection type 1 error as indicated in a block 604.

Otherwise when determined that the protection type 1 information check has not failed, then the data and the protection type 1 information from the first protection type 1 verification function 622 is placed into memory 624 as indicated in a block 606. Protection type 2 information is generated for the data placed into memory 624 from the first protection type 1 verification function 622 as indicated in a block 608. The protection type 2 information is placed into memory 624 as indicated in a block 610. The received data placed into memory 624 from the first protection type 1 verification function 622 is verified by the second protection type 1 verification function 628 as indicated in a block 612.

Next determining whether the second protection type 1 information check failed is performed as indicated in a decision block 614. When determined that this protection type 1 information check failed, then the data source 630 is notified of the protection type 1 error as indicated in a block 616. Otherwise when the determined that the protection type 1 information check has not failed, then the data and the generated protection type 2 information are transmitted to the destination 632 as indicated in a block 618.

While the present invention has been described with reference to the details of the embodiments of the invention shown in the drawing, these details are not intended to limit the scope of the invention as claimed in the appended claims.

What is claimed is:

1. A method for maintaining data integrity performed by a receiving device when switching between data protection methods comprising the steps of:
receiving data and a first protection type information;
generating a second protection type information;
responsive to generating said second protection type information, checking said received data using said first protection type information; and
generating an error indication when the first protection type information check fails.

2. A method for maintaining data integrity as recited in claim 1 includes storing said first protection type information.

3. A method for maintaining data integrity as recited in claim 2 includes storing said received data.

4. A method for maintaining data integrity as recited in claim 2 includes verifying data using said saved first protection type information simultaneously with generating said second protection type information before transmitting data.

5. A method for maintaining data integrity as recited in claim 4 wherein generating said error indication when the first protection type information check fails includes notifying a data source of an error.

6. A method for maintaining data integrity as recited in claim 4 includes transmitting data with said second protection type information to a destination when the first protection type information check does not fail.

7. A method for maintaining data integrity as recited in claim 2 includes verifying data using said saved first protection type information simultaneously with generating said second protection type information while transmitting data.

8. A method for maintaining data integrity as recited in claim 7 wherein generating said error indication when the first protection type information check fails includes transmitting invalid second protection type information for notifying a destination of an error.

9. A method for maintaining data integrity as recited in claim 7 further includes transmitting said generated second protection type information to a destination when the first protection type information check does not fail.

10. A method for maintaining data integrity as recited in claim 1 wherein generating said second protection type information is responsive to checking said received data using said first protection type information and first protection type information check does not fail.

11. A method for maintaining data integrity as recited in claim 10 further includes storing said generated second protection type information.

12. A method for maintaining data integrity as recited in claim 11 wherein generating said error indication when the first protection type information check fails further includes notifying a data source of an error.

13. A method for maintaining data integrity as recited in claim 12 further includes when the first protection type information check does not fail, transmitting data with said saved second protection type information to a destination.

14. Apparatus for maintaining data integrity when switching between data protection methods comprising:
a receiving device for receiving data and a first protection type information; said receiving device including:
a first protection type verification function for verifying said received data using said received first protection type information;
a second protection type generator function for generating a second protection type information for said received data;
said first protection type verification function, responsive to said second protection type information being generated, for checking said received data using said first protection type information; and for generating an error indication when the first protection type information check fails.

15. Apparatus for maintaining data integrity as recited in claim 14 further includes a memory for storing said received first protection type information.

16. Apparatus for maintaining data integrity as recited in claim 15 wherein said memory for storing said received data.

17. Apparatus for maintaining data integrity as recited in claim 15 wherein said memory for storing said generated second protection type information.

18. Apparatus for maintaining data integrity as recited in claim 14 wherein said first protection type verification function generating said error indication when the first protection type information check fails includes notifying a data source of an error.

19. Apparatus for maintaining data integrity as recited in claim 14 wherein said first protection type verification function generating said error indication when the first protection type information check fails includes notifying said second protection type generator function of said error indication.

20. Apparatus for maintaining data integrity as recited in claim 19 wherein said second protection type generator function transmits invalid second protection type information for notifying a destination of an error.
